(19) United States
(12) Patent Application Publication
(10) Pub. No.: US 2003/0100468 A1
(43) Pub. Date: May 29, 2003

(54) Nonaqueous, particulate-containing liquid detergent compositions with alkyl benzene sulfonate surfactant

(75) Inventors: Mark Allen Smerznak, Cincinnati, OH (US); Francesco deBuzzaccarini, Fairfield, OH (US); Vincent John Becks, Hamilton, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/304,938

(22) Filed: Nov. 26, 2002

Related U.S. Application Data
(63) Continuation of application No. 08/981,440, filed on Dec. 19, 1997, now abandoned.
Application No. 08/981,440 is a 371 of international application No. PCT/US96/07814, filed on May 28, 1996.

(51) Int. Cl. C11D 17/00

(52) U.S. Cl. 510/407; 510/424; 510/421

(57) ABSTRACT

Disclosed are nonaqueous, particulate-containing liquid laundry detergent compositions which are in the form of a suspension of particulate material, preferably including peroxygen bleaching agent and an organic detergent builder, dispersed in a liquid phase containing an alkylbenzene sulfonate anionic surfactant, an alcohol ethoxylate nonionic surfactant and a nonaqueous, low-polarity organic solvent. Such compositions provide especially desirable cleaning and bleaching of fabrics laundered therewith and also exhibit especially desirable pourability and chemical and phase stability.

### CROSS REFERENCE TO RELATED APPLICATION

This application is a continuation of U.S. Ser. No. 08/981,440, filed Dec. 19, 1997, which is incorporated by reference herein, which is a 371 of International Application No. PCT/US96/07814, filed May 28, 1996.

### FIELD OF THE INVENTION

This invention relates to liquid laundry detergent products which are nonaqueous in nature and which are in the form of stable dispersions of particulate material such as bleaching agents and/or other detergent composition adjuvants.

### BACKGROUND OF THE INVENTION

Liquid detergent products are often considered to be more convenient to use than are dry powdered or particulate detergent products. Liquid detergents have therefore found substantial favor with consumers. Such liquid detergent products are readily measurable, speedily dissolved in the wash water, capable of being easily applied in concentrated solutions or dispersions to soiled areas on garments to be laundered and are non-dusting. They also usually occupy less storage space than granular products. Additionally, liquid detergents may have incorporated in their formulations materials which could not withstand drying operations without deterioration, which operations are often employed in the manufacture of particulate or granular detergent products.

Although liquid detergents have a number of advantages over granular detergent products, they also inherently possess several disadvantages. In particular, detergent composition components which may be compatible with each other in granular products may tend to interact or react with each other in a liquid, and especially in an aqueous liquid, environment. Thus such components as enzymes, surfactants, perfumes, brighteners, solvents and especially bleaches and bleach activators can be especially difficult to incorporate into liquid detergent products which have an acceptable degree of chemical stability.

One approach for enhancing the chemical compatibility of detergent composition components in liquid detergent products has been to formulate nonaqueous (or anhydrous) liquid detergent compositions. In such nonaqueous products, at least some of the normally solid detergent composition components tend to remain insoluble in the liquid product and hence are less reactive with each other than if they had been dissolved in the liquid matrix. Nonaqueous liquid detergent compositions, including those which contain reactive materials such as peroxygen bleaching agents, have been disclosed for example, in Hepworth et al., U.S. Pat. No. 4,615,820, Issued Oct. 17, 1986; Schultz et al., U.S. Pat. No. 4,929,380, Issued May 29, 1990; Schultz et al., U.S. Pat. No. 5,008,031, Issued Apr. 16, 1991; Elder et al., EP-A-030,096, Published Jun. 10, 1981; Hall et al., WO 92/09678, Published Jun. 11, 1992 and Sanderson et al., EP-A-565,017, Published Oct. 13, 1993.

Even though chemical compatibility of components may be enhanced in nonaqueous liquid detergent compositions, physical stability of such compositions may become a problem. This is because there is a tendency for such products to phase separate as dispersed insoluble solid particulate material drops from suspension and settles at the bottom of the container holding the liquid detergent product. As one consequence of this type of problem, there can also be difficulties associated with incorporating enough of the right types and amounts of surfactant materials into nonaqueous liquid detergent products. Surfactant materials must, of course, be selected such that they are suitable for imparting acceptable fabric cleaning performance to such compositions but utilization of such materials must not lead to an unacceptable degree of composition phase separation. Phase stabilizers such as thickeners or viscosity control agents can be added to such products to enhance the physical stability thereof. Such materials, however, can add cost and bulk to the product without contributing to the laundering/cleaning performance of such detergent compositions.

It is also possible to select surfactant systems for such liquid laundry detergent products which can actually impart a structure to the liquid phase of the product and thereby promote suspension of particulate components dispersed within such a structured liquid phase. An example of such a product with a structured surfactant system is found in van der Hoeven et al.; U.S. Pat. No. 5,389,284; Issued Feb. 14, 1995, which utilizes a structured surfactant system based on relatively high concentrations of alcohol alkoxylate nonionic surfactants and anionic defloculating agents. In products which employ a structured surfactant system, the structured liquid phase must be viscous enough to prevent settling and phase separation of the suspended particulate material, but not so viscous that the pourability and dispensability of the detergent product is adversely affected.

Given the foregoing, there is clearly a continuing need to identify and provide liquid, particulate-containing detergent compositions in the form of nonaqueous liquid products that have a high degree of chemical, e.g., bleach and enzyme, stability along with commercially acceptable phase stability, pourability and detergent composition laundering, cleaning or bleaching performance. Accordingly, it is an object of the present invention to provide nonaqueous, particulate-containing liquid detergent products which have such especially desirable chemical and physical stability characteristics as well as outstanding pourability and fabric laundering/bleaching performance characteristics.

### SUMMARY OF THE INVENTION

The present invention provides nonaqueous liquid detergent compositions comprising a stable suspension of solid, substantially insoluble particulate material dispersed throughout a structured, surfactant-containing liquid phase. Such compositions comprise A) from about 35% to 99% by weight of the composition of a nonaqueous liquid phase; and B) from about 1% to 65% by weight of the composition of one or more types of particulate materials.

The nonaqueous liquid phase itself comprises from about 30% to 65% by weight of this liquid phase of a certain type of dissolved anionic surfactant. This anionic surfactant component comprises a material selected from the alkali metal salts of C₁₀-C₁₆ alkylbenzene sulfonic acids.

In addition to the anionic surfactant component, the nonaqueous liquid phase of the compositions herein also comprises from about 35% to 70% by weight of the liquid phase of a nonaqueous liquid diluent. Such a diluent comprises both i) alcohol alkoxylates of the formula R¹(OCₘH₂ₘ)ₙOH wherein R¹ is a C₈-C₁₆ alkyl group, m is from 2 to 4, and n is from about 2 to 12; and ii) a nonaqueous, low-polarity organic solvent. These components are present in the nonaqueous liquid diluent in an alcohol alkoxylate to organic solvent weight ratio of from about 50:1 to 1:50.

The particulate material suspended in the nonaqueous liquid phase of the compositions herein ranges in size from about 0.1 to 1500 microns and is substantially insoluble in the nonaqueous compositions herein. This insoluble particulate material preferably comprises a peroxygen bleaching agent, but may also comprise bleach activators, ancillary anionic surfactants, organic detergent builders, inorganic alkalinity sources and combinations of these particulate material types.

### DETAILED DESCRIPTION OF THE INVENTION

The nonaqueous liquid detergent compositions of this invention comprise a surfactant—and low-polarity solvent-containing liquid phase having dispersed therein as a solid phase certain types of particulate materials. The essential and optional components of the liquid and solid phases of the detergent compositions herein, as well as composition form, preparation and use, are described in greater detail as follows: (All concentrations and ratios are on a weight basis unless otherwise specified.)

Liquid Phase

The liquid phase will generally comprise from about 35% to 99% by weight of the detergent compositions herein. More preferably, the liquid phase will comprise from about 50% to 95% by weight of the compositions. Most preferably, the liquid phase will comprise from about 45% to 75% by weight of the compositions herein. The liquid phase of the detergent compositions herein essentially contains relatively high concentrations of a certain type anionic surfactant combined with a certain type of nonaqueous, liquid diluent.

(A) Essential Anionic Surfactant

The anionic surfactant essentially utilized as an essential component of the nonaqueous liquid phase is one selected from the alkali metal salts of alkylbenzene sulfonic acids in which the alkyl group contains from about 10 to 16 carbon atoms, in straight chain or branched chain configuration. (See U.S. Pat. Nos. 2,220,099 and 2,477,383, incorporated herein by reference.) Especially preferred are the sodium and potassium linear straight chain alkylbenzene sulfonates (LAS) in which the average number of carbon atoms in the alkyl group is from about 11 to 14. Sodum C₁₁-C₁₄ LAS is especially preferred.

The alkylbenzene sulfonate anionic surfactant will be dissolved in the nonaqueous liquid diluent which makes up the second essential component of the nonaqueous phase. To form the structured liquid phase required for suitable phase stability and acceptable rheology, the alkylbenzene sulfonate anionic surfactant is generally present to the extent of from about 30% to 65% by weight of the liquid phase. More preferably, the alkylbenzene sulfonate anionic surfactant will comprise from about 35% to 50% by weight of the nonaqueous liquid phase of the compostions herein. Utilization of this anionic surfactant in these concentrations corresponds to an anionic surfactant concentration in the total composition of from about 15% to 60% by weight, more preferably from about 20% to 40% by weight, of the composition.

(B) Nonaqueous Liquid Diluent

To form the liquid phase of the detergent compositions, the hereinbefore described alkylbenzene sulfonate anionic surfactant is combined with a nonaqueous liquid diluent which contains two essential components. These two components are a liquid alcohol alkoxylate material and a nonaqueous, low-polarity organic solvent.

i) Alcohol Alkoxylates

One essential component of the liquid diluent used to form the compositions herein comprises an alkoxylated fatty alcohol material. Such materials are themselves also nonionic surfactants. Such materials correspond to the general formula:

R¹(CₘH₂ₘO)ₙOH

wherein R¹ is a C₈ - C₁₆ alkyl group, m is from 2 to 4, and n ranges from about 2 to 12. Preferably R¹ is an alkyl group, which may be primary or secondary, that contains from about 9 to 15 carbon atoms, more preferably from about 10 to 14 carbon atoms. Preferably also the alkoxylated fatty alcohols will be ethoxylated materials that contain from about 2 to 12 ethylene oxide moieties per molecule, more preferably from about 3 to 10 ethylene oxide moieties per molecule.

The alkoxylated fatty alcohol component of the liquid diluent will frequently have a hydrophilic-lipophilic balance (HLB) which ranges from about 3 to 17. More preferably, the HLB of this material will range from about 6 to 15, most preferably from about 8 to 15.

Examples of fatty alcohol alkoxylates useful as one of the essential components of the nonaqueous liquid diluent in the compositions herein will include those which are made from alcohols of 12 to 15 carbon atoms and which contain about 7 moles of ethylene oxide. Such materials have been commercially marketed under the trade names Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide and Neodol 91-10, an ethoxylated C₉-C₁₁ primary alcohol having about 10 moles of ethylene oxide. Alcohol ethoxylates of this type have also been marketed by Shell Chemical Company under the Dobanol tradename. Dobanol 91-5 is an ethoxylated C₉-C₁₁ fatty alcohol with an average of 5 moles ethylene oxide and Dobanol 25-7 is an ethoxylated C₁₂-C₁₅ fatty alcohol with an average of 7 moles of ethylene oxide per mole of fatty alcohol.

Other examples of suitable ethoxylated alcohols include Tergitol 15-S-7 and Tergitol 15-S-9 both of which are linear secondary alcohol ethoxylates that have been commercially marketed by Union Carbide Corporation. The former is a mixed ethoxylation product of C₁₁ to C₁₅ linear secondary alkanol with 7 moles of ethylene oxide and the latter is a similar product but with 9 moles of ethylene oxide being reacted.

Other types of alcohol ethoxylates useful in the present compositions are higher molecular weight nonionics, such as Neodol 45-11, which are similar ethylene oxide condensation products of higher fatty alcohols, with the higher fatty alcohol being of 14-15 carbon atoms and the number of ethylene oxide groups per mole being about 11. Such products have also been commercially marketed by Shell Chemical Company.

The alcohol alkoxylate component which is essentially utilized as part of the liquid diluent in the nonaqueous compositions herein will generally be present to the extent of from about 1% to 60% of the liquid phase composition. More preferably, the alcohol alkoxylate component will comprise about 5% to 40% of the liquid phase. Most preferably, the essentially utilized alcohol alkoxylate component will comprise from about 5% to 30% of the detergent composition liquid phase. Utilization of alcohol alkoxylate in these concentrations in the liquid phase corresponds to an alcohol alkoxylate concentration in the total composition of from about 1% to 60% by weight, more preferably from about 2% to 40% by weight, and most preferably from about 5% to 25% by weight, of the composition.

ii) Nonaqueous Low-Polarity Organic Solvent

A second essential component of the liquid diluent which forms part of the liquid phase of the detergent compositions herein comprises nonaqueous, low-polarity organic solvent(s). The term “solvent” is used herein to connote the non-surface active carrier or diluent portion of the liquid phase of the composition. While some of the essential and/or optional components of the compositions herein may actually dissolve in the “solvent”-containing liquid phase, other components will be present as particulate material dispersed within the “solvent”-containing liquid phase. Thus the term “solvent” is not meant to require that the solvent material be capable of actually dissolving all of the detergent composition components added thereto.

The nonaqueous organic materials which are employed as solvents herein are those which are liquids of low polarity. For purposes of this invention, “low-polarity” liquids are those which have little, if any, tendency to dissolve one of the preferred types of particulate material used in the compositions herein, i.e., the peroxygen bleaching agents, sodium perborate or sodium percarbonate. Thus relatively polar solvents such as ethanol should not be utilized. Suitable types of low-polarity solvents useful in the nonaqueous liquid detergent compositions herein do include non-vicinal C₄-C₈ alkylene glycols, alkylene glycol mono lower alkyl ethers, lower molecular weight polyethylene glycols, lower molecular weight methyl esters and amides, and the like.

A preferred type of nonaqueous, low-polarity solvent for use in the compositions herein comprises the non-vicinal C₄-C₈ branched or straight chain alkylene glycols. Materials of this type include hexylene glycol (4-methyl-2,4-pentanediol), 1,6-hexanediol, 1,3-butylene glycol and 1,4-butylene glycol. Hexylene glycol is the most preferred.

Another preferred type of nonaqueous, low-polarity solvent for use herein comprises the mono-, di-, tri-, or tetra- C₂-C₃ alkylene glycol mono C₂-C₆ alkyl ethers. The specific examples of such compounds include diethylene glycol monobutyl ether, tetraethylene glycol monobutyl ether, dipropolyene glycol monoethyl ether, and dipropylene glycol monobutyl ether. Diethylene glycol monobutyl ether and dipropylene glycol monobutyl ether are especially preferred. Compounds of the type have been commercially marketed under the tradenames Dowanol, Carbitol, and Cellosolve.

Another preferred type of nonaqueous, low-polarity organic solvent useful herein comprises the lower molecular weight polyethylene glycols (PEGs). Such materials are those having molecular weights of at least about 150. PEGs of molecular weight ranging from about 200 to 600 are most preferred.

Yet another preferred type of non-polar, nonaqueous solvent comprises lower molecular weight methyl esters. Such materials are those of the general formula: R¹—C(O)—OCH₃ wherein R¹ ranges from 1 to about 18. Examples of suitable lower molecular weight methyl esters include methyl acetate, methyl propionate, methyl octanoate, and methyl dodecanoate.

The nonaqueous, low-polarity organic solvent(s) employed should, of course, be compatible and non-reactive with other composition components, e.g., bleach and/or activators, used in the liquid detergent compositions herein. Such a solvent component will generally be utilized in an amount of from about 1% to 70% by weight of the liquid phase. More preferably, the nonaqueous, low-polarity organic solvent will comprise from about 10% to 60% by weight of the liquid phase, most preferably from about 20% to 50% by weight, of the liquid phase of the composition. Utilization of this organic solvent in these concentrations in the liquid phase corresponds to a solvent concentration in the total composition of from about 1% to 50% by weight, more preferably from about 5% to 40% by weight, and most preferably from about 10% to 30% by weight, of the composition.

iii) Alcohol Alkoxylate To Solvent Ratio

The ratio of alcohol alkoxylate to organic solvent within the liquid diluent can be used to vary the rheological properties of the detergent compositions eventually formed. Generally, the weight ratio of alcohol alkoxylate to organic solvent will range from about 50:1 to 1:50. More preferably, this ratio will range from about 3:1 to 1:3.

iv) Liquid Diluent Concentration

As with the concentration of the alkylbenzene sulfonate anionic surfactant mixture, the amount of total liquid diluent in the nonaqueous liquid phase herein will be determined by the type and amounts of other composition components and by the desired composition properties. Generally, the liquid diluent will comprise from about 35% to 70% of the nonaqueous liquid phase of the compositions herein. More preferably, the liquid diluent will comprise from about 50% to 65% of the nonaqueous liquid phase. This corresponds to a nonaqueous liquid diluent concentration in the total composition of from about 15% to 70% by weight, more preferably from about 20% to 50% by weight, of the composition.

Solid Phase

The nonaqueous detergent compositions herein also essentially comprise from about 1% to 65% by weight, more preferably from about 5% to 50% by weight, of a solid phase of particulate material which is dispersed and suspended within the liquid phase. Generally such particulate material will range in size from about 0.1 to 1500 microns. More preferably such material will range in size from about 5 to 200 microns.

The particulate material utilized herein can comprise one or more types of detergent composition components which in particulate form are substantially insoluble in the nonaqueous liquid phase of the composition. The types of particulate materials which can be utilized are described in detail as follows:

(A) Peroxygen Bleaching Agent With Optional Bleach Activators

The most preferred type of particulate material useful for forming the solid phase of the detergent compositions herein comprises particles of a peroxygen bleaching agent. Such peroxygen bleaching agents may be organic or inorganic in nature. Inorganic peroxygen bleaching agents are frequently utilized in combination with a bleach activator.

Useful organic peroxygen bleaching agents include percarboxylic acid bleaching agents and salts thereof. Suitable examples of this class of agents include magnesium monoperoxyphthalate hexahydrate, the magnesium salt of metachloro perbenzoic acid, 4-nonylamino-4-oxoperoxybutyric acid and diperoxydodecanedioic acid. Such bleaching agents are disclosed in U.S. Pat. No. 4,483,781, Hartman, Issued Nov. 20, 1984; European Patent Application EP-A-133,354, Banks et al., Published Feb. 20, 1985; and U.S. Pat. No. 4,412,934, Chung et al., Issued Nov. 1, 1983. Highly preferred bleaching agents also include 6-nonylamino-6-oxoperoxycaproic acid (NAPAA) as described in U.S. Pat. No. 4,634,551, Issued Jan. 6, 1987 to Burns et al.

Inorganic peroxygen bleaching agents may also be used in particulate form in the detergent compositions herein. Inorganic bleaching agents are in fact preferred. Such inorganic peroxygen compounds include alkali metal perborate and percarbonate materials, most preferably the percarbonates. For example, sodium perborate (e.g. mono- or tetra-hydrate) can be used. Suitable inorganic bleaching agents can also include sodium or potassium carbonate peroxyhydrate and equivalent “percarbonate” bleaches, sodium pyrophosphate peroxyhydrate, urea peroxyhydrate, and sodium peroxide. Persulfate bleach (e.g., OXONE, manufactured commercially by DuPont) can also be used. Frequently inorganic peroxygen bleaches will be coated with silicate, borate, sulfate or water-soluble surfactants. For example, coated percarbonate particles are available from various commercial sources such as FMC, Solvay Interox, Tokai Denka and Degussa.

Inorganic peroxygen bleaching agents, e.g., the perborates, the percarbonates, etc., are preferably combined with bleach activators, which lead to the in situ production in aqueous solution (i.e., during use of the compositions herein for fabric laundering/bleaching) of the peroxy acid corresponding to the bleach activator. Various non-limiting examples of activators are disclosed in U.S. Pat. No. 4,915,854, Issued Apr. 10, 1990 to Mao et al.; and U.S. Pat. No. 4,412,934 Issued Nov. 1, 1983 to Chung et al. The nonanoyloxybenzene sulfonate (NOBS) and tetraacetyl ethylene diamine (TAED) activators are typical. Mixtures thereof can also be used. See also the hereinbefore referenced U.S. Pat. No. 4,634,551 for other typical bleaches and activators useful herein.

Other useful amido-derived bleach activators are those of the formulae:

R¹N(R⁵)C(O)R²C(O)L or R¹C(O)N(R⁵)R²C(O)L

wherein R¹ is an alkyl group containing from about 6 to about 12 carbon atoms, R² is an alkylene containing from 1 to about 6 carbon atoms, R⁵ is H or alkyl, aryl, or alkaryl containing from about 1 to about 10 carbon atoms, and L is any suitable leaving group. A leaving group is any group that is displaced from the bleach activator as a consequence of the nucleophilic attack on the bleach activator by the perhydrolysis anion. A preferred leaving group is phenol sulfonate.

Preferred examples of bleach activators of the above formulae include (6-octanamido-caproyl)oxybenzenesulfonate, (6-nonanamidocaproyl) oxybenzenesulfonate, (6-decanamido-caproyl)oxybenzenesulfonate and mixtures thereof as described in the hereinbefore referenced U.S. Pat. No. 4,634,551. Such mixtures are characterized herein as (6-C₈-C₁₀ alkamido-caproyl)oxybenzenesulfonate.

Another class of useful bleach activators comprises the benzoxazin-type activators disclosed by Hodge et al. in U.S. Pat. No. 4,966,723, Issued Oct. 30, 1990, incorporated herein by reference. A highly preferred activator of the benzoxazin-type is:

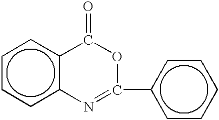

Still another class of useful bleach activators includes the acyl lactam activators, especially acyl caprolactams and acyl valerolactams of the formulae:

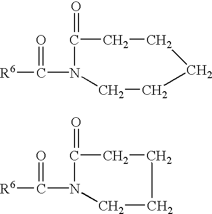

wherein R⁶ is H or an alkyl, aryl, alkoxyaryl, or alkaryl group containing from 1 to about 12 carbon atoms. Highly preferred lactam activators include benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, 3,5,5-trimethylhexanoyl valerolactam and mixtures thereof. See also U.S. Pat. No. 4,545,784, Issued to Sanderson, Oct. 8, 1985, incorporated herein by reference, which discloses acyl caprolactams, including benzoyl caprolactam, adsorbed into sodium perborate.

If peroxygen bleaching agents are used as all or part of the essentially present particulate material, they will generally comprise from about 1% to 30% by weight of the composition. More preferably, peroxygen bleaching agent will comprise from about 1% to 20% by weight of the composition. Most preferably, peroxygen bleaching agent will be present to the extent of from about 3% to 15% by weight of the composition. If utilized, bleach activators can comprise from about 0.5% to 20%, more preferably from about 1% to 10%, by weight of the composition. Frequently, activators are employed such that the molar ratio of bleaching agent to activator ranges from about 1:1 to 10:1, more preferably from about 1.5:1 to 5:1.

In addition, it has been found that bleach activators, when agglomerated with certain acids such as citric acid, are more chemically stable.

(B) Ancillary Anionic Surfactants

Another possible type of particulate material which can be suspended in the nonaqueous liquid detergent compositions herein includes ancillary anionic surfactants which are fully or partially insoluble in the nonaqueous liquid phase. The most common type of anionic surfactant with such solubility properties comprises primary or secondary alkyl sulfate anionic surfactants. Such surfactants are those produced by the sulfation of higher C₈-C₂₀ fatty alcohols.

Conventional primary alkyl sulfate surfactants have the general formula

ROSO₃^{-M}⁺

wherein R is typically a linear C₈-C₂₀ hydrocarbyl group, which may be straight chain or branched chain, and M is a water-solubilizing cation. Preferably R is a C₁₀-C₁₄ alkyl, and M is alkali metal. Most preferably R is about C₁₂ and M is sodium.

Conventional secondary alkyl sulfates may also be utilized as the essential anionic surfactant component of the solid phase of the compositions herein. Conventional secondary alkyl sulfate surfactants are those materials which have the sulfate moiety distributed randomly along the hydrocarbyl “backbone” of the molecule. Such materials may be depicted by the structure:

CH₃(CH₂)ₙ(CHOSO₃^{-M}⁺)(CH₂)ₘCH₃

wherein m and n are integers of 2 or greater and the sum of m +n is typically about 9 to 15, and M is a water-solubilizing cation.

If utilized as all or part of the requisite particulate material, ancillary anionic surfactants such as alkyl sulfates will generally comprise from about 1% to 10% by weight of the composition, more preferably from about 1% to 5% by weight of the composition. Alkyl sulfate used as all or part of the particulate material is prepared and added to the compositions herein separately from the unalkoxylated alkyl sulfate material which may form part of the alkyl ether sulfate surfactant component essentially utilized as part of the liquid phase herein.

(C) Organic Builder Material

Another possible type of particulate material which can be suspended in the nonaqueous liquid detergent compositions herein comprises an organic detergent builder material which serves to counteract the effects of calcium, or other ion, water hardness encountered during laundering/bleaching use of the compositions herein. Examples of such materials include the alkali metal, citrates, succinates, malonates, fatty acids, carboxymethyl succinates, carboxylates, polycarboxylates and polyacetyl carboxylates. Specific examples include sodium, potassium and lithium salts of oxydisuccinic acid, mellitic acid, benzene polycarboxylic acids and citric acid. Other examples of organic phosphonate type sequestering agents such as those which have been sold by Monsanto under the Dequest tradename and alkanehydroxy phosphonates. Citrate salts are highly preferred.

Other suitable organic builders include the higher molecular weight polymers and copolymers known to have builder properties. For example, such materials include appropriate polyacrylic acid, polymaleic acid, and polyacrylic/polymaleic acid copolymers and their salts, such as those sold by BASF under the Sokalan trademark.

Another suitable type of organic builder comprises the water-soluble salts of higher fatty acids, i.e., “soaps”. These include alkali metal soaps such as the sodium, potassium, ammonium, and alkylolammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap.

If utilized as all or part of the requisite particulate material, insoluble organic detergent builders can generally comprise from about 2% to 20% by weight of the compositions herein. More preferably, such builder material can comprise from about 4% to 10% by weight of the composition.

(D) Inorganic Alkalinity Sources

Another possible type of particulate material which can be suspended in the nonaqueous liquid detergent compositions herein can comprise a material which serves to render aqueous washing solutions formed from such compositions generally alkaline in nature. Such materials may or may not also act as detergent builders, i.e., as materials which counteract the adverse effect of water hardness on detergency performance.

Examples of suitable alkalinity sources include water-soluble alkali metal carbonates, bicarbonates, borates, silicates and metasilicates. Although not preferred for ecological reasons, water-soluble phosphate salts may also be utilized as alkalinity sources. These include alkali metal pyrophosphates, orthophosphates, polyphosphates and phosphonates. Of all of these alkalinity sources, alkali metal carbonates such as sodium carbonate are the most preferred.

The alkalinity source, if in the form of a hydratable salt, may also serve as a desiccant in the nonaqueous liquid detergent compositions herein. The presence of an alkalinity source which is also a desiccant may provide benefits in terms of chemically stabilizing those composition components such as the peroxygen bleaching agent which may be susceptible to deactivation by water.

If utilized as all or part of the particulate material component, the alkalinity source will generally comprise from about 1% to 25% by weight of the compositions herein. More preferably, the alkalinity source can comprise from about 2% to 15% by weight of the composition. Such materials, while water-soluble, will generally be insoluble in the nonaqueous detergent compositions herein. Thus such materials will generally be dispersed in the nonaqueous liquid phase in the form of discrete particles.

Optional Composition Components

In addition to the essential composition liquid and solid phase components as hereinbefore described, the detergent compositions herein can, and preferably will, contain various optional components. Such optional components may be in either liquid or solid form. The optional components may either dissolve in the liquid phase or may be dispersed within the liquid phase in the form of fine particles or droplets. Some of the materials which may optionally be utilized in the compositions herein are described in greater detail as follows:

(a) Optional Surfactants

Besides the essentially utilized alkylbenzene sulfonate surfactant materials and the alcohol alkoxylate component of the liquid diluent, the detergent compositions herein may, in addition to the optional alkyl sulfates hereinbefore described, also contain other types of surfactant materials. Such additional optional surfactants must, of course, be compatible with other composition components and must not substantially adversely affect composition rheology, stability or performance. Optional surfactants can be of the anionic, nonionic, cationic, and/or amphoteric type. If employed, optional surfactants will generally comprise from about 1% to 20% by weight of the compositions herein, more preferably from about 5% to 10% by weight of the compositions herein.

One common type of anionic surfactant material which may be optionally added to the detergent compositions herein comprises the alkyl polyalkoxylate sulfates. Alkyl polyalkoxylate sulfates are also known as alkoxylated alkyl sulfates or alkyl ether sulfates. Such materials are those which correspond to the formula

R²—O—(CₘH₂ₘO)ₙ—SO₃M

wherein R² is a C₁₀-C₂₂ alkyl group, m is from 2 to 4, n is from about 1 to 15, and M is a salt-forming cation. Preferably, R² is a C₁₂-C₁₈ alkyl, m is 2, n is from about 1 to 10, and M is sodium, potassium, ammonium, alkylammonium or alkanolammonium. Most preferably, R² is a C₁₂-C₁₆, m is 2, n is from about 1 to 6, and M is sodium. Ammonium, alkylammonium and alkanolammonium counterions are preferably avoided when the solid phase materials used in the compositions herein include a peroxygen bleaching agent.

Another common type of anionic surfactant material which may be optionally added to the detergent compositions herein comprises carboxylate-type anionics. Carboxylate-type anionics include the C₁₀-C₁₈ alkyl alkoxy carboxylates (especially the EO 1 to 5 ethoxycarboxylates) and the C₁₀-C₁₈ sarcosinates, especially oleoyl sarcosinate. Another common type of anionic surfactant material which may be optionally employed comprises other sulfonated anionic surfactants such as the C₈-C₁₈ paraffin sulfonates and the C₈-C₁₈ olefin sulfonates.

A preferred type of optional nonionic surfactant comprises surfactants which are ethylene oxide (EO)-propylene oxide (PO) block polymers. Materials of this type are well known nonionic surfactants which have been marketed under the tradename Pluronic. These materials are formed by adding blocks of ethylene oxide moieties to the ends of polypropylene glycol chains to adjust the surface active properties of the resulting block polymers. EO-PO block polymer nonionics of this type are described in greater detail in Davidsohn and Milwidsky; Synthetic Detergents, 7th Ed.; Longman Scientific and Technical (1987) at pp. 34-36 and pp. 189-191 and in U.S. Pat. Nos. 2,674,619 and 2,677,700. All of these publications are incorporated herein by reference. These Pluronic type nonionic surfactants are believed to function as effective suspending agents for the particulate material which is dispersed in the liquid phase of the detergent compositions herein.

Another preferred type of optional nonionic surfactant for use in the compositions herein comprises polyhydroxy fatty acid amide surfactants. Materials of this type of nonionic surfactant are those which conform to the formula:

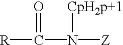

wherein R is a C₉₋₁₇ alkyl or alkenyl, p is from 1 to 6, and Z is glycityl derived from a reduced sugar or alkoxylated derivative thereof. Such materials include the C₁₂-C₁₈ N-methyl glucamides. Examples are N-methyl N-1-deoxyglucityl cocoamide and N-methyl N-1-deoxyglucityl oleamide. Processes for making polyhydroxy fatty acid, amides are know and can be found, for example, in Wilson, U.S. Pat. No. 2,965,576 and Schwartz, U.S. Pat. No. 2,703,798, the disclosures of which are incorporated herein by reference. The materials themselves and their preparation are also described in greater detail in Honsa, U.S. Pat. No. 5,174,937, Issued Dec. 26, 1992, which patent is also incorporated herein by reference.

(b) Optional Inorganic Detergent Builders

The detergent compositions herein may also optionally contain one or more types of inorganic detergent builders beyond those listed hereinbefore that also function as alkalinity sources. Such optional inorganic builders can include, for example, aluminosilicates such as zeolites. Aluminosilicate zeolites, and their use as detergent builders are more fully discussed in Corkill et al., U.S. Pat. No. No. 4,605,509; Issued Aug. 12, 1986, the disclosure of which is incorporated herein by reference. Also crystalline layered silicates, such as those discussed in this '509 U.S. Pat. No., are also suitable for use in the detergent compositions herein. If utilized, optional inorganic detergent builders can comprise from about 2% to 15% by weight of the compositions herein.

(c) Optional Enzymes

The detergent compositions herein may also optionally contain one or more types of detergent enzymes. Such enzymes can include proteases, amylases, cellulases and lipases. Such materials are known in the art and are commercially available. They may be incorporated into the nonaqueous liquid detergent compositions herein in the form of suspensions, “marumes” or “prills”. Another suitable type of enzyme comprises those in the form of slurries of enzymes in nonionic surfactants, e.g., the enzymes marketed by Novo Nordisk under the tradename “SL” or the microencapsulated enzymes marketed by Novo Nordisk under the tradename “LDP.”

Enzymes added to the compositions herein in the form of conventional enzyme prills are especially preferred for use herein. Such prills will generally range in size from about 100 to 1,000 microns, more preferably from about 200 to 800 microns and will be suspended throughout the nonaqueous liquid phase of the composition. Prills in the compositions of the present invention have been found, in comparison with other enzyme forms, to exhibit especially desirable enzyme stability in terms of retention of enzymatic activity over time. Thus, compositions which utilize enzyme prills need not contain conventional enzyme stabilizing such as must frequently be used when enzymes are incorporated into aqueous liquid detergents.

If employed, enzymes will normally be incorporated into the nonaqueous liquid compositions herein at levels sufficient to provide up to about 10 mg by weight, more typically from about 0.01 mg to about 5 mg, of active enzyme per gram of the composition. Stated otherwise, the nonaqueous liquid detergent compositions herein will typically comprise from about 0.001% to 5%, preferably from about 0.01% to 1% by weight, of a commercial enzyme preparation. Protease enzymes, for example, are usually present in such commercial preparations at levels sufficient to provide from 0.005 to 0.1 Anson units (AU) of activity per gram of composition.

(d) Optional Chelating Agents

The detergent compositions herein may also optionally contain a chelating agent which serves to chelate metal ions, e.g., iron and/or manganese, within the nonaqueous detergent compositions herein. Such chelating agents thus serve to form complexes with metal impurities in the composition which would otherwise tend to deactivate composition components such as the peroxygen bleaching agent. Useful chelating agents can include amino carboxylates, phosphonates, amino phosphonates, polyfunctionally-substituted aromatic chelating agents and mixtures thereof.

Amino carboxylates useful as optional chelating agents include ethylenediaminetetraacetates, N-hydroxyethyl-ethylenediaminetriacetates, nitrilotriacetates, ethylene-diamine tetrapropionates, triethylenetetraaminehexacetates, diethylenetriaminepentaacetates, ethylenediaminedisucci-nates and ethanoldiglycines. The alkali metal salts of these materials are preferred.

Amino phosphonates are also suitable for use as chelating agents in the compositions of this invention when at least low levels of total phosphorus are permitted in detergent compositions, and include ethylenediaminetetrakis (methylene-phosphonates) as DEQUEST. Preferably, these amino phosphonates do not contain alkyl or alkenyl groups with more than about 6 carbon atoms.

Preferred chelating agents include hydroxy-ethyldiphosphonic acid (HEDP), diethylene triamine penta acetic acid (DTPA), ethylenediamine disuccinic acid (EDDS) and dipicolinic acid (DPA) and salts thereof. The chelating agent may, of course, also act as a detergent builder during use of the compositions herein for fabric laundering/bleaching. The chelating agent, if employed, can comprise from about 0.1% to 4% by weight of the compositions herein. More preferably, the chelating agent will comprise from about 0.2% to 2% by weight of the detergent compositions herein.

(e) Optional Thickening, Viscosity Control and/or Dispersing Agents

The detergent compositions herein may also optionally contain a polymeric material which serves to enhance the ability of the composition to maintain its solid particulate components in suspension. Such materials may thus act as thickeners, viscosity control agents and/or dispersing agents. Such materials are frequently polymeric polycarboxylates but can include other polymeric materials such as polyvinylpyrrolidone (PVP).

Polymeric polycarboxylate materials can be prepared by polymerizing or copolymerizing suitable unsaturated monomers, preferably in their acid form. Unsaturated monomeric acids that can be polymerized to form suitable polymeric polycarboxylates include acrylic acid, maleic acid (or maleic anhydride), fumaric acid, itaconic acid, aconitic acid, mesaconic acid, citraconic acid and methylenemalonic acid. The presence in the polymeric polycarboxylates herein of monomeric segments, containing no carboxylate radicals such as vinylmethyl ether, styrene, ethylene, etc. is suitable provided that such segments do not constitute more than about 40% by weight of the polymer.

Particularly suitable polymeric polycarboxylates can be derived from acrylic acid. Such acrylic acid-based polymers which are useful herein are the water-soluble salts of polymerized acrylic acid. The average molecular weight of such polymers in the acid form preferably ranges from about 2,000 to 10,000, more preferably from about 4,000 to 7,000, and most preferably from about 4,000 to 5,000. Water-soluble salts of such acrylic acid polymers can include, for example, the alkali metal, salts. Soluble polymers of this type are known materials. Use of polyacrylates of this type in detergent compositions has been disclosed, for example, Diehl, U.S. Pat. No. 3,308,067, issued Mar. 7, 1967. Such materials may also perform a builder function.

If utilized, the optional thickening, viscosity control and/or dispersing agents should be present in the compositions herein to the extent of from about 0.1% to 4% by weight. More preferably, such materials can comprise from about 0.5% to 2% by weight of the detergents compositions herein.

(f) Optional Liquid Bleach Activators

The detergent compositions herein may also optionally contain bleach activators which are liquid in form at room temperature and which can be added as liquids to the nonaqueous liquid phase of the detergent compositions herein. One such liquid bleach activator is acetyl triethyl citrate (ATC). Other examples include glycerol triacetate and nonanoyl valerolactam. Liquid bleach activators can be dissolved in the nonaqueous liquid phase of the compositions herein.

(g) Optional Brighteners, Suds Suppressors, Dyes and/or Perfumes

The detergent compositions herein may also optionally contain conventional brighteners, suds suppressors, silicone oils, bleach catalysts, dyes and/or perfume materials. Such brighteners, suds suppressors, silicone oils, bleach catalysts, dyes and perfumes must, of course, be compatible and non-reactive with the other composition components in a nonaqueous environment. If present, brighteners suds suppressors, dyes and/or perfumes will typically comprise from about 0.0001% to 2% by weight of the compositions herein. Suitable bleach catalysts include the manganese based complexes disclosed in U.S. Pat. No. 5,246,621, U.S. Pat. No. 5,244,594, U.S. Pat. No. 5,114,606 and U.S. Pat. No. 5,114,611.

Composition Form

As indicated, the nonaqueous liquid detergent compositions herein are in the form of bleaching agent and/or other materials in particulate form as a solid phase suspended in and dispersed throughout a nonaqueous liquid phase. Generally, the nonaqueous liquid phase will comprise from about 35% to 99%, more preferably from about 50% to 95%, by weight of the composition with the dispersed solid phase comprising from about 1% to 65%, more preferably from about 5% to 50%, by weight of the composition.

The particulate-containing liquid detergent compositions of this invention are substantially nonaqueous (or anhydrous) in character. While very small amounts of water may be incorporated into such compositions as an impurity in the essential or optional components, the amount of water should in no event exceed about 5% by weight of the compositions herein. More preferably, water content of the nonaqueous detergent compositions herein will comprise less than about 1% by weight.

The particulate-containing nonaqueous liquid detergent compositions herein will be relatively viscous and phase stable under conditions of commercial marketing and use of such compositions. Frequently the viscosity of the compositions herein will range from about 300 to 5,000 cps, more preferably from about 500 to 3,000 cps. For purposes of this invention, viscosity is measured with a Brookfield Viscometer using a RV #5 spindle at 50 rpm.

Composition Preparation and Use

The nonaqueous liquid detergent compositions herein can be prepared by combining the essential and optional components thereof in any convenient order and by mixing, e.g., agitating, the resulting component combination to form the phase stable compositions herein. In a typical process for preparing such compositions, essential and certain preferred optional components will be combined in a particular order and under certain conditions.

In the first step of such a typical preparation process, an admixture of the alkylbenzene sulfonate anionic surfactant and the two essential components of the nonaqueous diluent is formed by heating a combination of these materials to a temperature from about 30° C. to 100° C.

In a second process step, the heated admixture formed as hereinbefore described is maintained under shear agitation at a temperature from about 40° C. to 100° C. for a period of from about 2 minutes to 20 hours. Optionally, a vaccuum can be applied to the admixture at this point. This second process step serves to completely dissolve the anionic surfactant in the nonaqueous liquid phase.

In a third process step, this liquid phase combination of materials is cooled to a temperature of from about 0° C. to 35° C. This cooling step serves to form a structured, surfactant-containing liquid base into which the particulate material of the detergent compositions herein can be added and dispersed.

Particulate material is added in a fourth process step by combining the particulate material with the liquid base which is maintained under conditions of shear agitation. When more than one type of particulate material is to be added, it is preferred that a certain order of addition be observed. For example, while shear agitation is maintained, essentially all of any optional surfactants in solid particulate form can be added in the form of particles ranging in size from about 0.2 to 1,000 microns. After addition of any optional surfactant particles, particles of substantially all of an organic builder, e.g., citrate and/or fatty acid, and/or an alkalinity source, e.g., sodium carbonate, can be added while continuing to maintain this admixture of composition components under shear agitation. Other solid form optional ingredients can then be added to the composition at this point. Agitation of the mixture is continued, and if necessary, can be increased at this point to form a uniform dispersion of insoluble solid phase particulates within the liquid phase.

After some or all of the foregoing solid materials have been added to this agitated mixture, the particles of the highly preferred peroxygen bleaching agent can be added to the composition, again while the mixture is maintained under shear agitation. By adding the peroxygen bleaching agent material last, or after all or most of the other components, and especially after alkalinity source particles, have been added, desirable stability benefits for the peroxygen bleach can be realized. If enzyme prills are incorporated, they are preferably added to the nonaqueous liquid matrix last.

As a final process step, after addition of all of the particulate material, agitation of the mixture is continued for a period of time sufficient to form compositions having the requisite viscosity and phase stability characteristics. Frequently this will involve agitation for a period of from about 1 to 30 minutes.

As a variation of the composition preparation procedure hereinbefore described, one or more of the solid components may be added to the agitated mixture as a slurry of particles premixed with a minor portion of one or more of the liquid components. Thus a premix of a small fraction of the alcohol alkoxylate and/or nonaqueous, low-polarity solvent with particles of the organic builder material and/or the particles of the inorganic alkalinity source and/or particles of a bleach activator may be separately formed and added as a slurry to the agitated mixture of composition components. Addition of such slurry premixes should precede addition of peroxygen bleaching agent and/or enzyme particles which may themselves be part of a premix slurry formed in analogous fashion.

The compositions of this invention, prepared as hereinbefore described, can be used to form aqueous washing solutions for use in the laundering and bleaching of fabrics. Generally, an effective amount of such compositions is added to water, preferably in a conventional fabric laundering automatic washing machine, to form such aqueous laundering/bleaching solutions. The aqueous washing/bleaching solution so formed is then contacted, preferably under agitation, with the fabrics to be laundered and bleached therewith.

An effective amount of the liquid detergent compositions herein added to water to form aqueous laundering/bleaching solutions can comprise amounts sufficient to form from about 500 to 7,000 ppm of composition in aqueous solution. More preferably, from about 800 to 3,000 ppm of the detergent compositions herein will be provided in aqueous washing/bleaching solution.

### EXAMPLE

The following example illustrates the compositions of the present invention, but are not necessarily meant to limit or otherwise define the scope of the invention herein.

A bleach-containing nonaqueous liquid laundry detergent is prepared having the composition as set forth in Table I.

TABLE I

| Component | Wt. % |
|---|---|
| Liquid Phase | |
| Na C₁₂ Linear alkylbenzene sulfonate (LAS) | 27.3 |
| C₁₂₋₁₄, EO = 5 alcohol ethoxylate | 13.6 |
| Hexylene glycol | 27.3 |
| Perfume | 0.4 |
| Solids | |
| Protease enzyme | 0.4 |
| Na₃ Citrate, anhydrous | 4.3 |
| Sodium perborate | 3.4 |
| Sodium nonanoyloxybenzene sulfonate (NOBS) | 8.0 |
| Sodium carbonate | 13.9 |
| Diethyl triamine pentaacetic acid (DTPA) | 0.9 |
| Brightener | 0.4 |
| Suds Suppressor | 0.1 |
| Minors | 0.4 |
| | 100% |

Such a composition is prepared by mixing the LAS, hexylene glycol and alcohol ethoxylate together at 54° C. (130° F.) for ½ hour. This mixture is then cooled to 29° C. (85° F.) whereupon the remaining components are added. The resulting composition is then stirred at 29° C. (85° F.) for another ½ hour.

The resulting composition is a stable anhydrous heavy duty liquid laundry detergent which provides excellent stain and soil removal performance when used in normal fabric laundering operations.

What is claimed is:

1. A nonaqueous, liquid heavy-duty detergent composition in the form of a suspension of a solid, substantially insoluble particulate material dispersed throughout a structured, surfactant-containing liquid phase, said composition being further characterized in that it comprises:
A) from about 35% to 99% by weight of the composition of a nonaqueous liquid phase which comprises:
i) from about 30% to 65% by weight of said nonaqueous liquid phase of a dissolved anionic surfactant selected from alkali metal salts of C₁₀-C₁₆ alkylbenzene sulfonic acid; and
ii) from about 35% to 70% by wieght of said nonaqueous liquid phase of a nonaqueous liquid diluent which comprises:
a) alcohol alkoxylates of the formula R¹(OCₘH₂ₘ)ₙOH wherein R¹ is a C₈-C₁₆ alkyl group, m is from 2 to 4 and n is from about 2 to 12; and
b) a nonaqueous, low-polarity, organic solvent;
in an alcohol alkoxylate to organic solvent weight ratio of from about 50:1 to 1:50; and
B) from about 1% to 65% by weight of the composition of particulate material which ranges in size from about 0.1 to 1,500 microns, which is substantially insoluble in said nonaqueous liquid phase and which is selected from peroxygen bleaching agents, bleach activators, ancillary anionic surfactants, organic detergent builders, inorganic alkalinity sources and combinations of said particulate material types.

2. A composition according to claim 1 wherein
(A) the alkyl group of said alkylbenzene sulfonic acid is linear and contains from about 11 to 14 carbon atoms;
(B) said alcohol alkoxylate component comprises ethoxylated materials containing from about 8 to 15 carbon atoms and having from about 3 to 10 ethylene oxide moieties per molecule;
(C) said nonaqueous low-polarity organic solvent is selected from
i) mono, di, tri, tetra C₂-C₃ alkylene glycol mono C₂-C₆ alkyl ethers; and
ii) non-vicinal alkylene glycols containing from about 4 to 8 carbon atoms; and
(D) said particulate material comprises peroxygen bleaching agents selected from percarboxylic acids and salts thereof and alkali metal perborates and percarbonates.

3. A composition according to claim 2 wherein
(A) said alkylbenzene sulfonic anionic surfactant comprises from about 15% to 60% by weight of the composition;
(B) said nonaqueous liquid diluent comprises from about 15% to 70% by weight of the composition and has an alcohol ethoxylate to organic solvent ratio of from about 3:1 to 1:3; and
(C) said particulate material comprises from about 5% to 50% by weight of the composition.

4. A composition according to claim 3 wherein
(A) said peroxygen bleaching agent is selected from alkali metal perborates and percarbonates and comprises from about 1% to 30% by weight of the composition; and
(B) said particulate material also comprises from about 0.5% to 20% by weight of the composition of particles of a bleach activator which can react with said peroxygen bleaching agent to form a peroxy acid.

5. A composition according to claim 4 which also contains from about 1% to 20% by weight of the composition of an additional nonionic surfactant comprising ethylene oxide-propylene oxide block polymers.

6. A composition according to claim 4 wherein said particulate material also comprises from about 2% to 20% by weight of the composition of an organic detergent builder selected from alkali metal citrates, succinates, malonates, carboxymethylsuccinates, carboxylates, polycarboxylates, polyacetylcarboxylates and fatty acid soaps.

7. A composition according to claim 6 wherein said organic detergent builder is sodium citrate.

8. A composition according to claim 4 wherein said particulate material also comprises from about 1% to 25% by weight of the composition of an alkalinity source selected from water-soluble alkali metal carbonates, bicarbonates, borates, silicates and metasilicates.

9. A composition according to claim 8 wherein said alkalinity source is sodium carbonate.

10. A composition according to claim 4 which additionally contains from about 0.1% to 4% by weight of the composition of a chelating agent selected from amino carboxylates, phosphonates, amino phosphonates, polyfunctional substituted aromatic chelating agents and combinations of these chelating agents.

11. A composition according to claim 10 wherein said chelating agent is selected from diethylene triamine pentaacetic acid, ethylene diamine disuccinic acid, dipicolinic acid and hydroxyethyldiphosphonic acid and the salts of these chelating agents.

12. A composition according to claim 4 which additionally contains from about 0.001% to 5% by weight of the composition of enzyme prills wherein said prills range in size from about 100 to 1,000 microns, and wherein said enzyme is selected from proteases, amylases, cellulases, and lipases.

13. A composition according to claim 4 which additionally contains
(A) from about 0.1% to 4% by weight of the composition of a thickening, viscosity control and/or dispersing agent selected from acrylic acid-based polymers having a molecular weight ranging from about 2,000 to 10,000; and/or
(B) from about 0.0001% to 2% by weight of a compatible brightener, suds suppressor, silicone oil, bleach catalyst, dye and/or perfume.

14. A nonaqueous liquid heavy-duty detergent composition in the form of a suspension of solid, substantially insoluble particulate peroxygen bleaching agent material dispersed throughout a structured, surfactant-containing liquid phase having a viscosity of from about 300 to 5,000 cps, said composition being further characterized in that it comprises:
(A) from about 15% to 60% by weight of the composition of an alkali metal C₁₁-C₁₄ linear alkyl benzene sulfonate surfactant;
(B) from about 15% to 70% by weight of the composition of a nonaqueous liquid diluent which comprises:
i) an alcohol ethoxylate component comprising C₁₀-C₁₄ alcohols containing from about 3 to 10 moles of ethylene oxide; and
ii) a nonaqueous organic solvent selected from diethylene glycol monobutyl ether, dipropylene glycol monobutyl ether and hexylene glycol;
in an alcohol ethoxylate to organic solvent weight ratio of from about 3:1 to 1:3; and
(C) from about 1% to 20% by weight of the composition of particles of a peroxygen bleaching agent selected from sodium and potassium perborates and percarbonates, said particles ranging in size from about 5 to 200 microns.

15. A composition according to claim 14 wherein said composition further comprises from about 1% to 10% by weight of the composition of particles of a bleach activator which can react with said peroxygen bleaching agent to form a peroxy acid.

16. A composition according to claim 15 which additionally contains from about 4% to 10% by weight of the composition or an organic detergent builder selected from alkali metal citrates, succinates, malonates, carboxymethylsuccinates, carboxylates, polycarboxylates, polyacetylcarboxylates and fatty acid soaps.

17. A composition according to claim 16 which additionally contains from about 2% to 15% by weight of an alkalinity source selected from water-soluble alkali metal carbonates, bicarbonates, borates, silicates and metasilicates.

18. A nonaqueous, bleach-containing liquid heavy-duty detergent composition which comprises:
(A) from about 20% to 40% by weight of the composition of a sodium C₁₁₋₁₄ linear alkylbenzene sulfonate anionic surfactant;
(B) from about 5% to 25% by weight of the composition of a C₁₀-C₁₄, 1-3 EO alcohol ethoxylate;
(C) from about 10% to 30% by weight of the composition of hexylene glycol or dipropylene glycol monobutyl ether;
(D) from about 1% to 20% by weight of the composition of particles of a peroxygen bleaching agent selected from sodium and potassium perborates and percarbonates;
(E) from about 1% to 10% by weight of the composition of particles of a bleach activator selected from nonanoyloxybenzene sulfonate, (6-C₈-C₁₀ alkamido-caproyl) oxybenzene sulfonate and tetraacetyl ethylene diamine; and
(F) from about 2% to 15% by weight of the composition of particles of alkali metal carbonate; and
wherein said composition is in the form of a suspension of particulate material comprising said particles, dispersed throughout said liquid detergent composition with said particulate material ranging in size from about 0.1 to 1500 microns.

19. A composition according to claim 18 which has from about 50% to 95% by weight of the composition of a liquid phase and from about 5% to 50% by weight of the composition of a solid particulate phase.

20. A composition according to claim 19 which has a viscosity of from about 500 to 3,000 cps.
